(19) United States
(12) Patent Application Publication
(10) Pub. No.: US 2026/0099338 A1
(43) Pub. Date: Apr. 9, 2026

(54) LARGE LANGUAGE MODEL DEPLOYMENT

(71) Applicant: Wells Fargo Bank, N.A., San Francisco, CA (US)

(72) Inventors: Krishnakumar Chellappa, Indian Land, SC (US); Shamsher Dhaka, Freemont, CA (US)

(21) Appl. No.: 18/905,979

(22) Filed: Oct. 3, 2024

(51) Int. Cl. G06F 9/445

(52) U.S. Cl. CPC G06F 9/44505

(57) ABSTRACT

An example computer system for deploying one or more large language models, the computer system comprising: one or more processors; and non-transitory computer-readable storage media encoding instructions which, when executed by the one or more processors, causes the computer system to: manage deployment of one or more machine learning models; generate model configuration files, wherein the model configuration files implement the one or more machine learning models in one or more environments and provide a specification library used to configure the one or more machine learning models; determine scores of a performance of the one or more machine learning models in the one or more environments; and store the model configuration files that are used to deploy each corresponding machine learning model.

### BACKGROUND

Many software services are provided for business solutions. To access the software services, an architecture and framework can be deployed in a local instance (on-premises or “on-prem”) or in a cloud instance. A business can then tailor the software services to integrate into their existing information technology (“IT”) system. Machine learning models can be deployed in a similar fashion. A particular machine learning model can be used for different purposes in a variety of systems. However, the machine learning model must be configured to handle a system's particular data set and data format. Further, the machine learning model must be integrated into the specific architecture of the specified system.

### SUMMARY

Examples provided herein are directed to large language model deployment.

According to one aspect, a computer system for deploying one or more large language models, the computer system comprising: one or more processors; and non-transitory computer-readable storage media encoding instructions which, when executed by the one or more processors, causes the computer system to: manage deployment of one or more machine learning models; generate model configuration files, wherein the model configuration files implement the one or more machine learning models in one or more environments and provide a specification library used to configure the one or more machine learning models; determine scores of a performance of the one or more machine learning models in the one or more environments; and store the model configuration files that are used to deploy each corresponding machine learning model.

According to another aspect, a method for deploying one or more machine learning models, the method comprising: developing a machine learning model for one or more use cases; operationalizing the machine learning model for the one or more use cases; deploying the machine learning model to one or more client devices; and operating the machine learning model on the one or more client devices.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for deploying large language models.

FIG. 2 shows example logical components of a server device of the system of FIG. 1.

FIG. 3 shows an additional view of the system of FIG. 1.

FIG. 4 shows an example method for deploying large language models using the system of FIG. 1.

FIG. 5 shows example physical components of the server device of FIG. 2.

### DETAILED DESCRIPTION

This disclosure relates to deployment of large language models.

Entities deploy machine learning models so that they can be used at various endpoints. For example, a business entity may offer machine learning capabilities integrated within a software service that it offers. In additional examples, the entity may utilize the machine learning model to analyze a large amount of data and make inferences. For instance, the model may analyze login attempts to a financial institution's account. Based on certain metadata, such as the type of browser used to login, the model can flag the account for further investigation for potential fraud.

A single machine learning model may be used for different purposes or in different systems. For example, it may be desirable for two systems with different architectures to use the same machine learning model. The machine learning model can be operationalized to integrate with each architecture, which involves additional overhead for each different system. Traditional systems include implementing custom application programming interface (“API”) wrapper code for each system the model will be deployed. Additional configuration for processing the desired data set will also be needed.

Embodiments of the present disclosure provide an automation framework for deploying machine learning models to on-premises (“on-prem”) or public cloud systems. The automation framework may be a RESTful Automation Framework (“RAF”) that can use Java. The RAF minimizes the custom wrapper code, encapsulating common concerns like request, response and header validation, request handling, configurable scoring pipeline etc., thus saving development efforts on average.

RESTful framework is a software framework designed to simplify the development of web applications that adhere to the principles of Representational State Transfer (“REST”). REST provides a structured approach for building APIs (Application Programming Interfaces) that allow different software systems to communicate with each other over the internet. RESTful frameworks focus on modeling data as resources, typically represented by URLs. Each resource has associated hypertext transfer protocol (“HTTP”) methods (GET, POST, PUT, DELETE, etc.) that define the allowed operations on that resource.

RESTful interactions are stateless, meaning each request from the client to the server contains all the necessary information to complete that request. The server does not maintain any session information between requests. RESTful frameworks rely on a standardized set of HTTP methods and status codes for consistent communication. This simplifies integration between different systems. RESTful APIs can leverage caching mechanisms to improve performance by storing frequently accessed data locally on the client or intermediate servers.

The RAF accelerates deployments of machine learning models by providing an automated framework that handles data processing and system integration. In addition, the RAF extends current artificial intelligence (“AI”)/machine learning (“ML”) model deployments to a unified framework to handle both real time and batch deployments. In some embodiments, the RAF also enables scoring of machine learning models, by providing java runtime for scoring from python applications.

Additional capabilities the RAF provides include a light-weight framework and easily deployable on on-prem public cloud platforms. The RAF is configured to integrate models such that data from applications can be streamed for inferencing. In some embodiments, the RAF is automated using continuous integration/continuous deployment (“CI/CD”). Other features also include model monitoring performance and hardware utilization. For example, the RAF enables for automatic switching between a graphics processor unit (“GPU”) and a central processing unit (“CPU”) to accelerate performance with minimal configurations. Further, a single point of configuration can be edited to conduct model configuration changes.

In addition, the RAF enables the deployed machine learning models to receive data from any database within an entity's system. The entity's system may include multiple databases with data stored in many different formats. The RAF deploys the machine learning models with little to no change in underlying code or the API wrapper for the model, and the model can still receive data from the multiple databases within the entity's system. In some embodiments, the RAF is independent of a platform or system architecture (i.e., Windows or Linux).

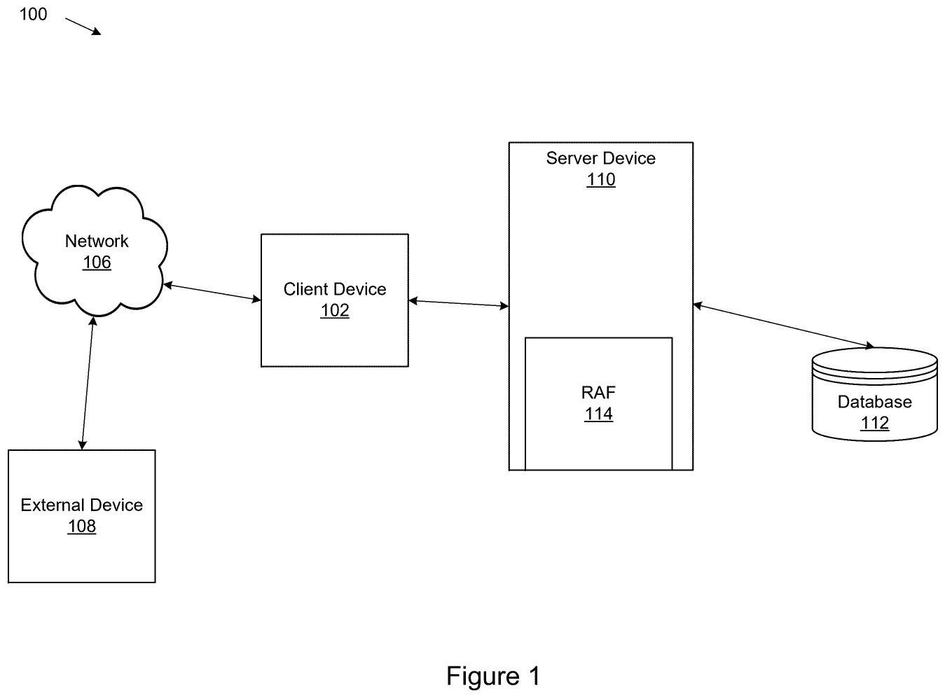

FIG. 1 shows an example system 100 for deploying large language models. The system 100 includes a server device 110 that connects to a client device 102. The client device 102 connects to an external device 108 through a network 106. Further, the server device 110 connects to a database 112. The server device 110 also includes a RAF 114.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 110 is owned by a financial institution, such as a bank. The client device 102 can be programmed to communicate with the server device 110 to perform various tasks, such as financial transactions. Many other configurations are possible, and the disclosure is not limitation to the financial industry.

The server device 110 maintains the RAF 114 for model deployment. Many devices, such as the client device 102, may need access to a machine learning model. Further, input data may be received from many databases, such as the database 112. The server device 110 uses the RAF 114 to deploy the models to be compatible to operate on the client device 102 and receive data from the database 112. Moreover, the server device uses Java to program the RAF 114.

For example, the server device 110 can be used to deploy a machine learning model to the client device 102. The server device 110 uses Java to deploy the model to the server device with little to no change to the underlying code of the machine learning model. The custom API wrapper code remain the same to increase efficiency of deployment. Further, the model is configured to receive data from the database 112, regardless of the format of the data within the database.

In some embodiments, the server device 110 uses Jakarta RESTful Web Services (“JAX-RS”). JAX-RS is a Java API specification for building RESTful web services. JAX-RS makes the development of RESTful web services in Java simpler and more standardized. It uses annotations to map Java classes and methods to URIs and HTTP methods, defining how the service interacts with clients. Further, JAX-RS is a specification, meaning it defines the API and behavior.

Using JAX-RS, the server device 110 can offer improvements to using other types of systems, such as those that use Spring Model-View-Controller (“Spring MVC”), since the underlying code of the server device 110 does not need to be updated each time a new feature is released. Instead, the server device 110 replaces the JAX-RS specification library without updating the underlying code. The Spring Framework is an open-source application framework for building enterprise applications. Spring MVC is a popular web framework built on top of the Spring Framework. In some embodiments, the server device 110 generates a configuration file that implements the machine learning models in one or more environments and provides a specification library used to configure the machine learning models.

It provides a structured and flexible way to develop web applications in Java by implementing the MVC design pattern.

In some embodiments, the server device 110's end-to-end model deployment lifecycle, validation, and services are governed by configuration files. The configuration files help in catering many use cases/domains by allowing additional configuration files for each of the use cases. Further, the server device 110 leverages the single unified deployed RAF 114 in any hybrid environment for a complete ML lifecycle.

In addition, the server device 110 connects to other devices for deployment of the machine learning model. For example, the server device 110 can be used to deploy the machine learning model to the client device 102. Moreover, the same machine learning model can be deployed to a separate device that has different operating parameters. The server device 110 deploys the model with little to no changes of the underlying code of the machine learning model. Accordingly, the machine learning model can be deployed with less overhead to integrate the model with the parameters of each client device.

The client device 102 receives the machine learning model from the server device 110 that is being deployed. For example, the machine learning model may be used to support users of the client device 102, such as a chatbot to help customers access the financial institution. In some embodiments, the machine learning model is used to help developers manage large amounts of data or analyze failure data of calls. For example, the client device 102 may use the machine learning model.

The example external device 108 is used by customers and/or team members of the financial institution to perform various tasks. For instance, a team member of the financial institution can use the client device 102 to perform tasks such as access financial settings and documents, transactional accounts, etc. Similarly, a customer of the financial institution may access the client device 102 to perform such tasks.

The database 112 stores data that is used by the system 100 to deploy machine learning models. In some embodiments, the database 112 stores specifications and libraries for deploying the machine learning models. In addition, the database 112 can store training data or other input data for the deployed machine learning models. In some embodiments, the database 112 stores output from the machine learning models.

The database 112 can store data that is structured or in a natural format. The RAF 114 of the server device 110 is compatible with any relational database or non-relational database on account of the portability of the RAF 114. Accordingly, the database 112 can be configured to store data in a variety of formats. In some embodiments, the database 112 stores JavaScript Object Notation (JSON) data.

In some embodiments, the database 112 is a relational database. A relational database is a type of database that stores data in structured tables with predefined relationships between them. It is based on the relational model, where data is organized into rows and columns, and each row represents a unique record or entity. Relationships between tables are established using keys, allowing for efficient data retrieval and manipulation. Relational databases are designed to store structured data, meaning data that has a well-defined format and schema. Each table has a fixed set of columns with specific data types, ensuring data consistency and integrity. The relational database may use Structured Query Language (SQL).

In some embodiments, the database 112 is a non-relational database, such as MongoDB. A non-relational database, also known as a NoSQL database, is a type of database that stores data in a format other than the traditional table-based relational model. Instead of tables with rows and columns, non-relational databases use various data models such as key-value pairs, documents, graphs, or wide-column stores, depending on the specific needs of the application.

Non-relational databases are schema-less or have flexible schemas, meaning that the structure of the data can be changed easily without affecting the entire database. This makes them well-suited for handling unstructured or semi-structured data that may evolve over time. They are designed to scale horizontally across multiple servers, making them ideal for handling large volumes of data and high traffic loads. Non-relational databases in some circumstances offer faster read and write operations compared to relational databases, especially for specific types of queries or data access patterns. The different data models offered by non-relational databases are optimized for certain types of data and use cases. For example, document databases are good for storing JSON-like data, while graph databases are excellent for representing relationships between entities.

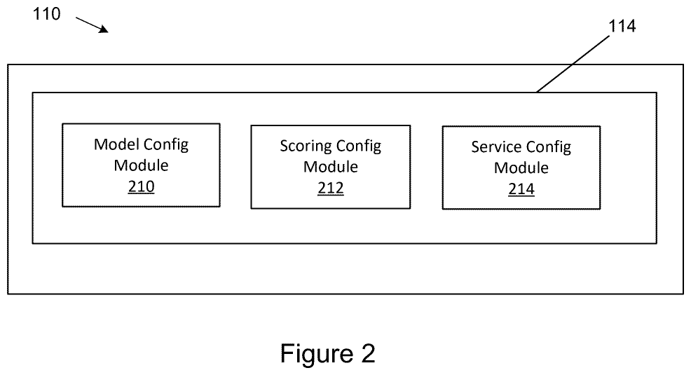

FIG. 2 shows example logical components of the server device 110 of the system 100. As previously discussed, the server device 110 includes the RAF 114. The RAF 114 includes a model config module 210, a scoring config module 212, and a service config module 214.

The model config module 210 provides files that include the configuration specifications for the machine learning model. Also, the model config module 210 governs validation and services capabilities, which helps adapt the machine learning model to many use cases.

Further, the underlying code for each machine learning model since the model config module 210 controls and configures the model. Further, the model config module 210 generates one or more model configuration files for each machine learning model. The machine learning model uses a specification library provided by the one or more model configuration files. In some embodiments, the specification library defines the core APIs and annotations that form the foundation of the JAX-RS framework. It outlines the standard interfaces, classes, and annotations that developers use to build RESTful web services in Java.

The model config module 210 also protects RESTful endpoints for each stage of the machine learning model lifecycle since the underlying technology and code are obfuscated because of the machine learning model being programmed by the model config module 210. The model config module 210 can include configurations for deployment stages such as configurations for the source code, configurations for machine learning operationalizing, configurations for CI/CD, and configurations for maintaining the machine learning model in a cloud instance or an on-prem instance.

In addition, the model config module 210 configures hyper parameters of the machine learning model. In some embodiments, the additional parameters can be added such as features encountered in the data but not considered in training. Each hyper parameter can be tuned for each machine learning model. Further, the hyper parameters within the model config module 210 can be used to tune the machine learning model and change its output. Rather than tuning the machine learning model through changing the underlying code, the model config module 210 can update the configuration file for the particular machine learning model.

In some embodiments, the model config module 210 receives the configuration files from the service config module 214. After updating or generating new configuration files, the model config module 210 provides the configuration files to the service config module 214 for storage. The parameters within these configuration files can be edited to update the machine learning model without changing the underlying code, such as the custom API wrapper code.

In some embodiments, the model config module 210 manages deploying the machine learning model to the client device 102. For example, the model config module 210 may manage deployment of a plurality of machine learning models. Once a machine learning model is selected for the client device 102, the model config module 210 deploys the machine learning model to the client device 102. The model config module 210 manages each phase of deployment. To deploy the model, the model config module 210 uses a corresponding model configuration file. Once selected, the model config module 210 can configure the selected machine learning model for integration into the operating environment of the client device 102.

In some embodiments, the model config module 210 develops a machine learning model for a different use case by generating a new model configuration file. The model config module 210 may use a machine learning model template or already in use model configuration file to generate the new model configuration file for the new use case.

In some embodiments, the model config module 210 updates each machine learning model by changing some of the parameters in one or more model configuration files. For example, a machine learning model may be updated to a new version. Each use case with a corresponding model configuration file can be updated by making the necessary edits to each corresponding model configuration file.

The scoring config module 212 provides different environments for operating the machine learning model. In some embodiments, the scoring config module 212 provides an environment for validating the machine learning model. For example, the machine learning model can be tested to ensure it behaves as intended in a particular environment. The environment may be a quality assurance testing environment or a production environment. In some embodiments, the scoring config module 212 determines scores for the machine learning model in one or more environments.

In some embodiments, the scoring config module 212 indicates an origination of data that is input into the machine learning model, and/or indicates a destination of output data from the machine learning model. Further, the scoring config module 212 separates the data for each machine learning model and each environment.

Moreover, the scoring config module 212 stores the scores of a machine learning model for a particular environment. The scores provide the machine learning model's performance in a specified environment. The scoring config module 212 also stores the parameters used for a particular test in a specified environment. Output of the scoring config module 212 can also be provided to the client device 102 for display to a user.

In some embodiments, the scoring config module 212 provides scoring information in real-time. The scoring information may be provided to an external storage or database such as the database 112 for future access. The scoring information may be provided as data to an external system.

The service config module 214 stores configuration files that are used to deploy each corresponding machine learning model. In some embodiments, the service config module 214 stores the configuration files of each machine learning model in a JSON file. In some embodiments, the service config module 214 stores each configuration file in a text file.

Further, the service config module 214 stores templates for each machine learning model for different use cases. The service config module 214 can also have multiple slots for each environment. For example, a small system may have five slots for when to score a machine learning model in a particular environment.

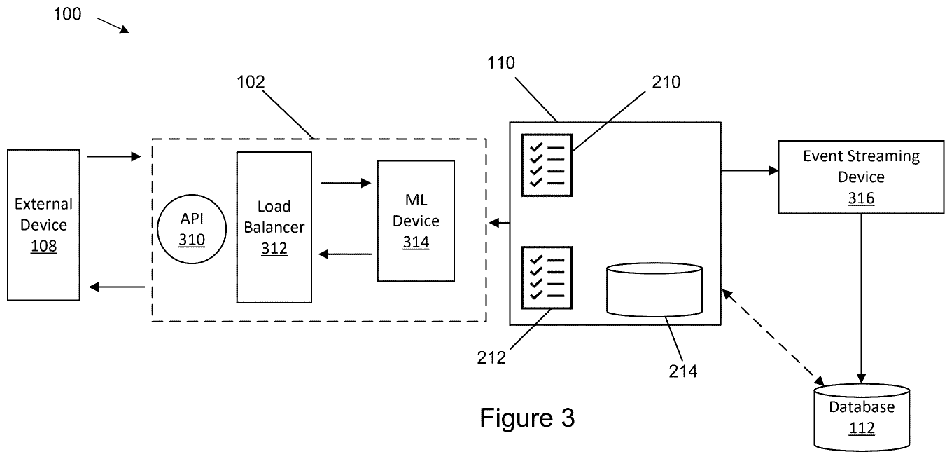

FIG. 3 shows an additional view of the system 100. In this embodiment, the external device 108 connects to a load balancer 312 through an API 310. The load balancer 312 manages access to a ML device 314. The ML device receives the deployed machine learning model from the server device 110. Further, the server device 110 connects to an event streaming device 316, which provides data to the database 112.

The external device 108 can access the machine learning model through the API 310. The API 310 allows external devices to access the ML device 314, which contains the machine learning model. Accordingly, the external device 108 can use features provided by the ML device 314 or analyze data by the ML device 314. For example, the external device 108 can use the ML device 314 to answer a question as a chatbot or analyze failure attempts to login into a financial account. In some embodiments, the external device 108 is a customer device used to access machine learning model assets. In some embodiments, the external device 108 is a device used to develop internal software systems or manage internal systems and uses the machine learning model to analyze data. In some embodiments, the API 310 is a RESTful endpoint.

The load balancer 312 manages requests for access to the ML device 314. A load balancer is a critical networking solution that intelligently distributes incoming network traffic across multiple servers or resources, ensuring optimal resource utilization, enhanced performance, and high availability for web applications and services.

By acting as a traffic director, the load balancer 312 efficiently routes requests to the most suitable server based on factors such as server load, health status, and predefined algorithms. This prevents any single server from becoming overloaded, mitigating bottlenecks and minimizing response times, resulting in a faster and more seamless user experience.

Furthermore, the load balancer 312 can contribute to high availability by automatically redirecting traffic away from failed or unhealthy servers, ensuring uninterrupted service even in the event of server outages. They also facilitate scalability by enabling the addition or removal of servers as needed, allowing applications to seamlessly adapt to fluctuating traffic demands without disruption.

The ML device 314 connects to the server device 110. Further, the ML device 314 is selected as an on-prem or cloud-based device to host the machine learning model. The ML device 314 may be a server device that operates the machine learning model. As the external device 108 makes requests or provides data, the ML device 314 responds to the request and analyzes any necessary data using the integrated machine learning model.

In some embodiments, the ML device 314 is included with the server device 110. In some embodiments, the ML device 314 is multiple devices that connect to form a system. In some embodiments, the client device 102 includes the ML device 314 and the load balancer 312. In some embodiments, the client device does not include the ML device 314 or the load balancer 312.

The server device 110 deploys a selected machine learning model to the ML device 314. For example, a machine learning model that analyzes account login failure may be selected. Then, the server device 110 uses the model config module 210, the scoring config module 212, and the service config module 214 to configure the selected machine learning model and deploy the machine learning model to the ML device 314. External devices can then utilize the machine learning model by calling the API 310 to connect to the ML device 314.

The event streaming device 316 receives scoring data from the server device 110. As the scoring config module 212 scores the machine learning models in different environments, the real-time feed of data is received by the event streaming device 316. The data is then stored in the database 112. Data from the database 112 can also be directly retrieved from the database 112 by the server device 110. In some embodiments, the event streaming device 316 is configured to monitor real-time scoring of one or more machine learning models.

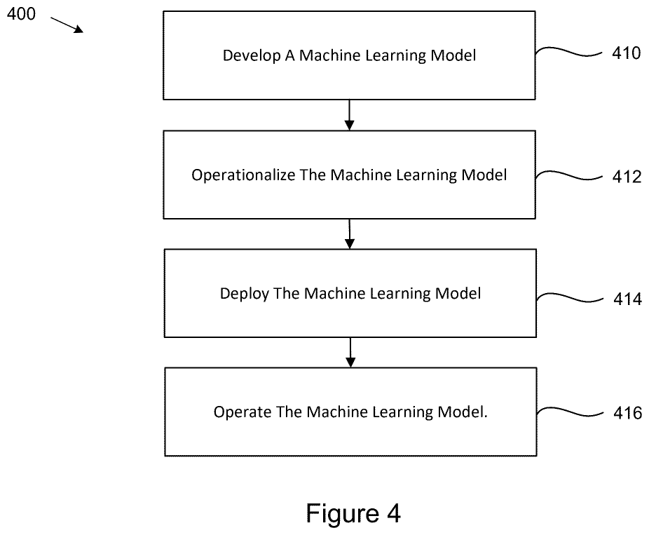

FIG. 4 shows an example method 400 for deploying machine learning models using the system 100. In some embodiments, some or all of the shown operations may be performed by the server device 110. In some embodiments, other devices may perform one or more of the discussed operations.

At operation 410, a machine learning model is developed. This operation may include configuring a machine learning model for deployment to another device, such as the client device 102. For example, a machine learning model may be selected for deployment that analyzes account login failure data. The machine learning model is trained to analyze login metadata. The login metadata may include a type of browser. If a user normally logins on a first browser type, such as Google Chrome, then the model may flag the account login for fraud if the login attempt was through a second browser type, such as Microsoft Edge. The configuration file may be stored in a repository, such as the database 112 or the service config module 214.

Further, developing the machine learning model may include producing the source code. Then, the source code may be managed by a model configuration file, which allows the machine learning model to be used for multiple use cases.

At operation 412, the machine learning model is operationalized. At this operation, the machine learning model may be configured to handle data. For example, the machine learning model may be configured with a location to receive data, a location to send output, and a function to analyze or otherwise handle data. Operationalizing the model may include verifying the model is suitable for a selected purpose. For example, the model may be configured to integrate in the client device 102 or the ML device 314 for analyzing login failure data.

At operation 414, the machine learning model is deployed to a selected device. Deploying the machine learning model may include continuous monitoring and continuous development. In some embodiments, deploying the model includes determining an instance type. For example, infrastructure setup requirements, such as those for Amazon Webservices, Microsoft Azure, or Google Cloud, are implemented with the machine learning model. Deployment activities may be scheduled as well for implementing the machine learning model in the chosen environment.

At operation 416, the machine learning model is operated within the infrastructure instance. The machine learning model may be implemented in the client device 102 or the ML device 314. The machine learning model is then ready for a question and response to external devices such as the external device 108. Operating the machine learning model may include maintaining the machine learning model at the RESTful endpoints. For example, the external device 108 may access the machine learning model using the RESTful endpoint.

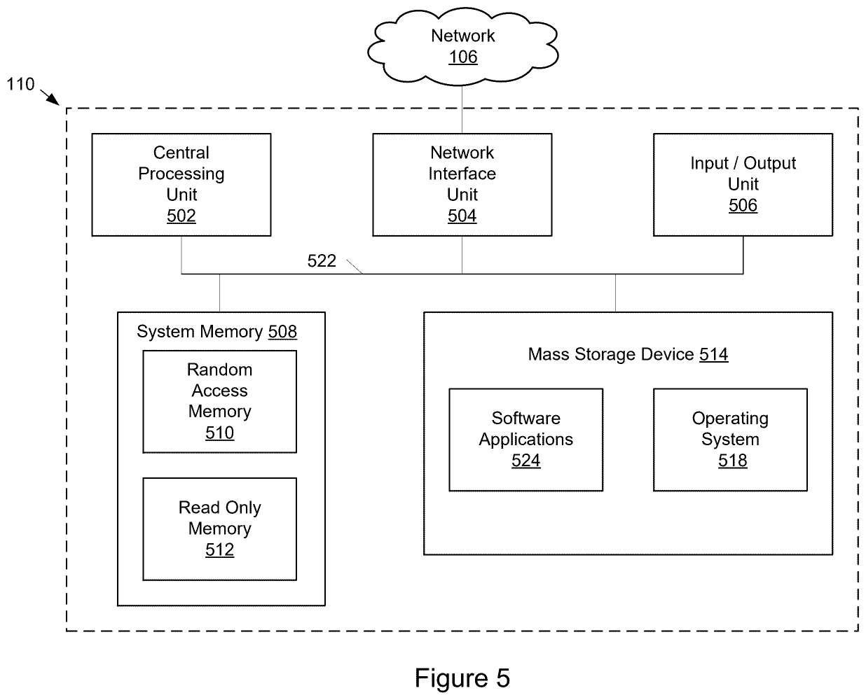

As illustrated in the embodiment of FIG. 5, the example server device 110, which provides at least some of the functionality described herein, can include at least one central processing unit (“CPU”) 502, a system memory 508, and a system bus 522 that couples the system memory 508 to the CPU 502. The system memory 508 includes a random-access memory (“RAM”) 510 and a read-only memory (“ROM”) 512. A basic input/output system containing the basic routines that help transfer information between elements within the server device 110, such as during startup, is stored in the ROM 512. The server device 110 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the server device 110. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 110.

According to various embodiments of the invention, the server device 110 may operate in a networked environment using logical connections to remote network devices through network 106, such as a wireless network, the Internet, or another type of network. The server device 110 may connect to network 106 through a network interface unit 504 connected to the system bus 522. It should be appreciated that the network interface unit 504 may also be utilized to connect to other types of networks and remote computing systems. The server device 110 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the server device 110 can store software instructions and data. The software instructions include an operating system 518 suitable for controlling the operation of the server device 110. The mass storage device 514 and/or the RAM 510 also store software instructions and applications 524, that when executed by the CPU 502, cause the server device 110 to provide the functionality of the server device 110 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for deploying one or more large language models, the computer system comprising:
one or more processors; and
non-transitory computer-readable storage media encoding instructions which, when executed by the one or more processors, causes the computer system to:
manage deployment of one or more machine learning models;
generate model configuration files, wherein the model configuration files implement the one or more machine learning models in one or more environments and provide a specification library used to configure the one or more machine learning models;
determine scores of a performance of the one or more machine learning models in the one or more environments; and
store the model configuration files that are used to deploy each corresponding machine learning model.

2. The computer system of claim 1, wherein the instructions further cause the computer system to maintain the one or more machine learning model on-premises or in a cloud instance.

3. The computer system of claim 2, wherein the one or more machine learning models are accessed through a RESTful endpoint.

4. The computer system of claim 3, wherein an external device accesses the one or more machine learning models through the RESTful endpoint.

5. The computer system of claim 1, wherein the instructions further cause the computer system to monitor real-time scoring data of the one or more machine learning models.

6. The computer system of claim 5, wherein the event streaming device stores the scoring data in a database.

7. The computer system of claim 6, wherein the database is a relational database or a non-relational database.

8. The computer system of claim 1, wherein the instructions further cause the computer system to update a model configuration file to update the one or more machine learning models.

9. The computer system of claim 8, wherein updating the one or more machine learning models are completed without updating underlying code of the one or more machine learning models.

10. The computer system of claim 9, wherein updating the model configuration file is further programmed to generate a new model configuration file based on a machine learning model template.

11. A method for deploying one or more machine learning models, the method comprising:
developing a machine learning model for one or more use cases;
operationalizing the machine learning model for the one or more use cases;
deploying the machine learning model to one or more client devices; and
operating the machine learning model on the one or more client devices.

12. The method of claim 11, further comprising generating one or more model configuration files corresponding to the one or more machine learning models.

13. The method of claim 12, wherein the machine learning model is developed from the one or more configuration files.

14. The method of claim 13, wherein each of the one or more configuration files correspond to at least one of the one or more-use cases.

15. The method of claim 11, further comprising scoring the one or more machine learning models for the one or more use cases.

16. The method of claim 15, further comprising storing scoring data in a database.

17. The method of claim 16, wherein the database is a relational database or a non-relational database.

18. The method of claim 11, further comprising determining an instance type for deploying the machine learning model.

19. The method of claim 18, wherein the instance type is on-premises or a cloud instance.

20. The method of claim 18, further comprising accessing the machine learning model through a Representational State Transfer (“RESTful”) API.
